(19) United States
(12) Patent Application Publication
(10) Pub. No.: US 2015/0019240 A1
(43) Pub. Date: Jan. 15, 2015

(54) SYSTEM FOR TRANSLATING TARGET WORDS BY GESTURE AND METHOD THEREOF

(71) Applicants: INVENTEC (PUDONG) TECHNOLOGY CORPORATION, Shanghai (CN); INVENTEC CORPORATION, Taipei (TW)

(72) Inventor: Wei YIN, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/275,969

(22) Filed: May 13, 2014

(30) Foreign Application Priority Data
Jul. 12, 2013 (CN) 201310294076.5

(51) Int. Cl. G06F 17/28

(52) U.S. Cl. CPC G06F 17/289
USPC 705/2

(57) ABSTRACT

A system for translating a target word by a gesture and a method thereof are provided. By inputting a gesture for text, selecting a target word from the text based on the gesture, and displaying a translation of the target word, the system and method can achieve an effect of obtaining a translation of words conveniently and fast for user of a touch device having the system and method employed therein.

### BACKGROUND OF THE INVENTION

### Field of Invention

The present invention relates to a translating system and a method thereof, particularly to a translating system and a method thereof for translating a target word according to a corresponding gesture.

Most digital devices do not provide any translation service, and thus a user has to use the on-line translation function when the language shown on the device is unfamiliar to him/her. Even a digital having the translation function or the on-line translation function is used, but the user on the device has to transform the current frame to a translation application. That is, the user change different interfaces to translate, it's an inconvenience to the user.

In this regard, some translation software or on-line translation services provide a plug-in. When the user expects to translate target words, the plug-in may be first activated and then the translation software or on-line translation service translates the target words. Although the plug-in may reduce a trouble from inputting words, the user still has to switch the different interfaces. It is inconvenience for translating on touch device.

In view of the above, It needs new technology to overcome the inconvenience of translating on a touch device for a long time

### SUMMARY OF THE INVENTION

In view of the problem in the prior art, the present invention discloses a system and method of translating a target word according to a gesture applied on a touch device.

the present invention, the system of translating a target word by a gesture applied on a touch device comprises an inputting module, which is for inputting a gesture on the text; a selection module, which is for selecting a target word by the gesture, the target word belonging the text; a translating module, which is for translating the target word into a second language as a translation; and a displaying module, which is for displaying the translation.

In the present invention, the method of translating a target word by a gesture, comprising steps of inputting a gesture on the text; selecting a target word by the gesture, the target word belonging the text; translating the target word into a second language as a translation; and displaying the translation.

The technical feature of the present invention is that inputting a gesture on a text, selecting a target word based on the gesture and translating the target word into a translation. In such way, user may rapidly obtain a translation for a target word on a touch device.

### BRIEF DESCRIPTION OF THE DRAWINGS

The invention will become more fully understood from the detailed description given herein below illustration only, and thus is not limitative of the present invention, and wherein:

FIG. 1 is an architecture diagram of a system of translating a target word according to a gesture according to the present invention;

FIG. 2A is a flowchart of a method of translating a target word according to a gesture according to the present invention;

FIG. 2B is an additional flowchart of a process of restoring and displaying a target word according to the present invention;

FIG. 3A-3E are schematic diagrams of gestures forth by embodiments of the present invention; and

FIG. 4 is a schematic diagram of translation displayed in an overlapped manner set forth in the present invention.

### DETAILED DESCRIPTION OF THE INVENTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

The present invention is applied onto a touch device and provides a user to input a particular gesture to select a word displayed by the touch device to be translated, improving a convenience of translation function. The “gesture” is a touch action of one or more fingers on a touch device, and referred to as a “gesture” in the present invention.

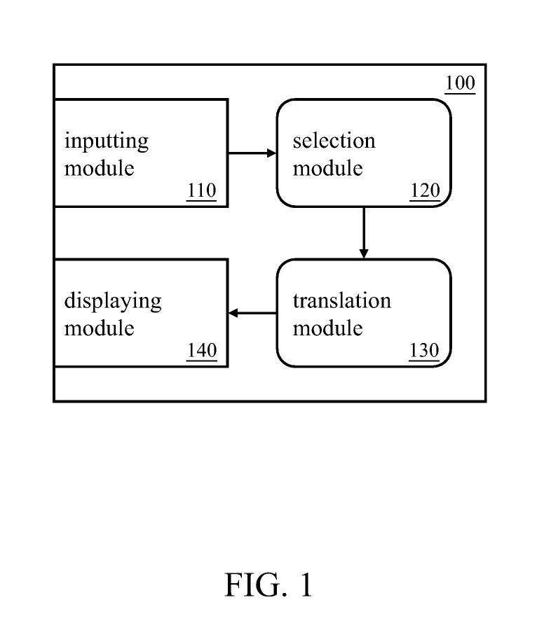

FIG. 1 is an architecture diagram of a system of translating a target word based on a gesture according to the present invention. Referring to FIG. 1, the system 100 comprises an inputting module 110, a selection module 120, translation module 130, and a displaying module.

The inputting module 110 is used for inputting a gesture by a user for a target word to be translated in text displayed in a touch device. The gesture may be a sliding over top and below of the target word, or a sliding over right and left of the target word. In addition, in a case, such as, the target word showed on two rows, there needs a symbol “-” displayed at an ending position of a row next to a first portion of the target and a beginning position of a next row before a second portion of the target, the gesture should slide along a first portion by finger and slide along a second portion by the same or another finger.

In the case where the target word shows on multi-rows, the gesture should slide over top or below a part of the target word and slide over top or below the other part of the target word after sliding the part of the target word, wherein the other part of the target word is one or more words of row(s) following the part of the target word. Any gesture clearly pointing out the target word may be used as the gesture as mentioned in the present invention.

The inputting module 110 also can input a withdraw gesture, which is, the withdraw gesture slides the opposite direction to the gesture. For example, when the gesture is slide from left to right, the withdraw gesture slide from right to left.

The selection module 120 selects a target word from the text displayed on the touch device based on the gesture inputted from the inputting module 110.

The selection module 120 may select a range of the target word by the following ways: taking a beginning point and an ending point of the target word by a shorter sliding distance over top and below of the target word, and selecting the target word from the text. Or, taking the beginning point and the ending point of the target word according to an overlapping percent that the gesture on each row of the text, and selecting the target word from the text. Or, taking a beginning point and the ending point of the target word according to the beginning of a first sliding gesture and the end of a second sliding gesture on the text, and selecting the target word from the text. However, these ways of selecting the target word in the selection module 120 are only exemplified, not to be used to limit the present invention.

The translation module 130 is used to translate the target word into a translation. For example, the target word is Chinese, and the translation of the target word is English.

The displaying module 140 displays the translation generated from the translation module 130. In some embodiments, the displaying module 140 may display the translation that in instead of the target word where the target word was. However, this displaying way is only exemplified, not to be used to limit the present invention. If inputting a withdraw gesture, the displaying module 140 will display the target word on the same position again, don't display the translation.

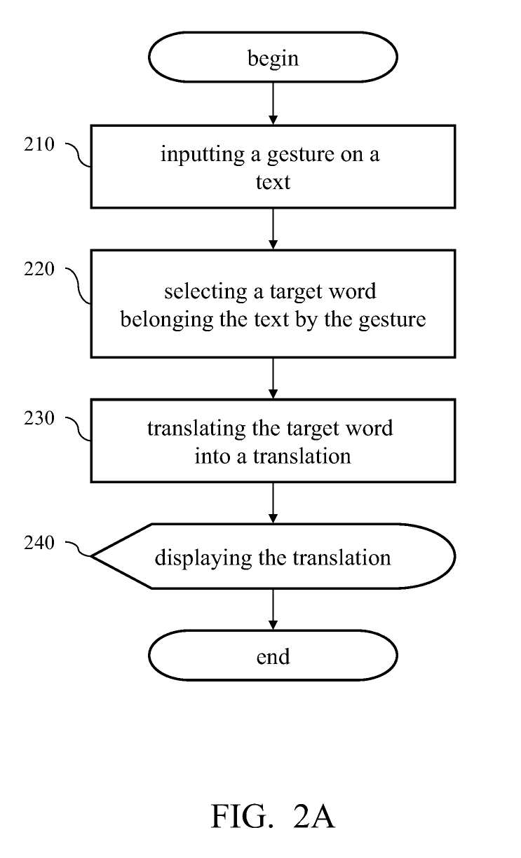

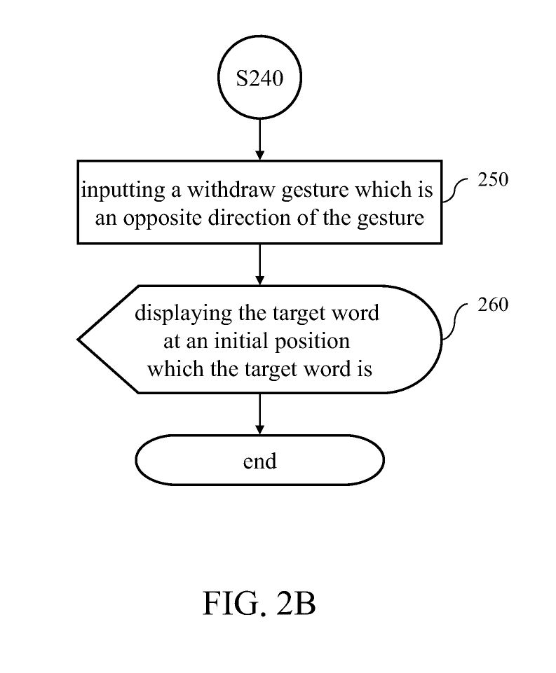

Now, an embodiment is exemplified to describe the operation of the system and method of the present invention, with reference to FIG. 2A at the same time, in which a flowchart of a method of translating a target word on a gesture according to the present invention is shown. Assume the touch device be a tablet computer or a smart phone, but which is not used to limit the present invention.

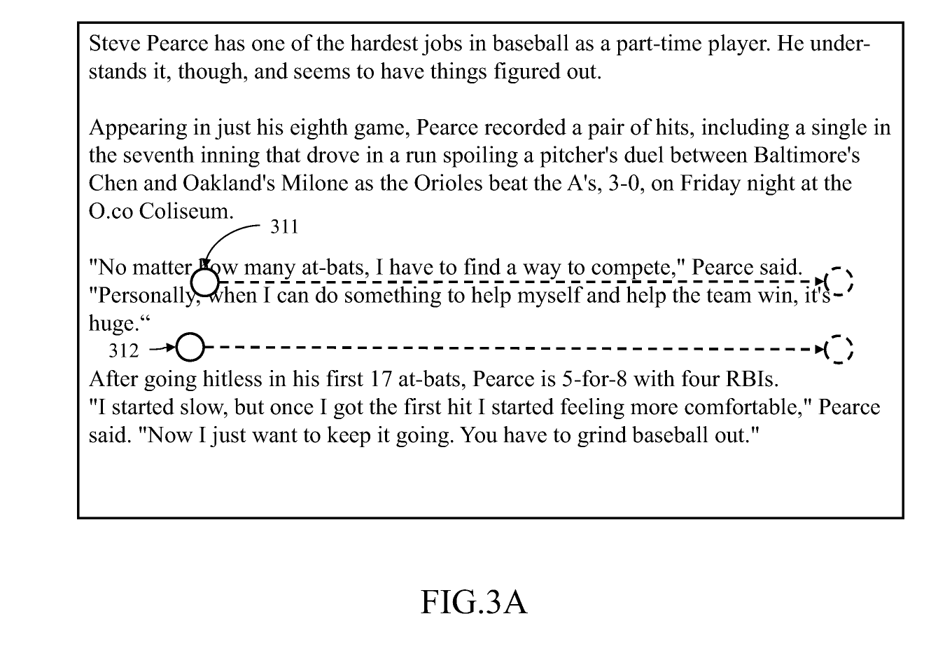

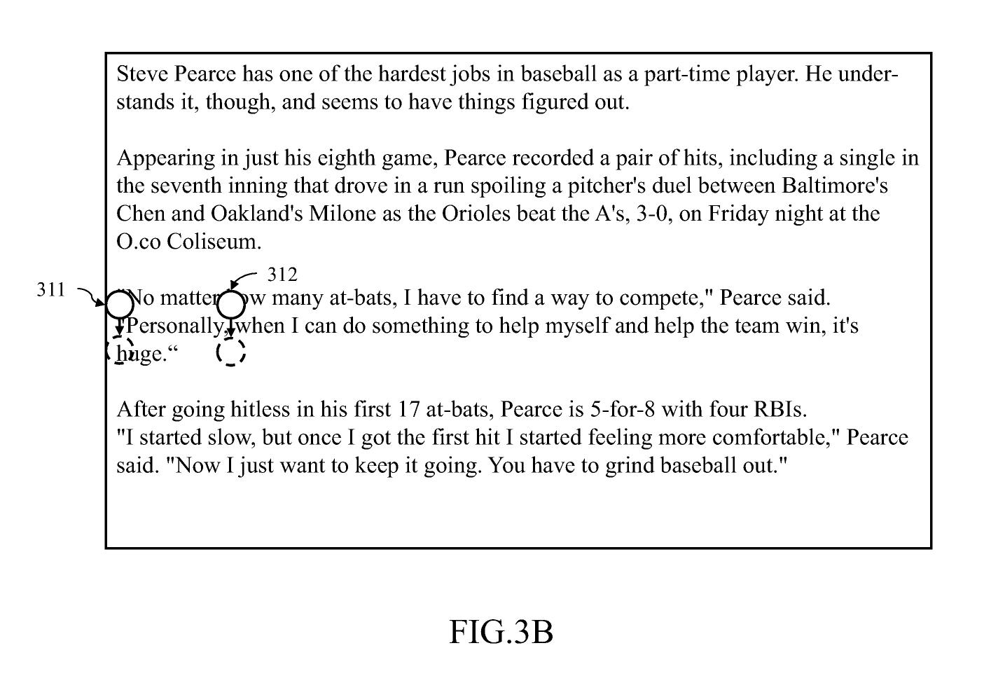

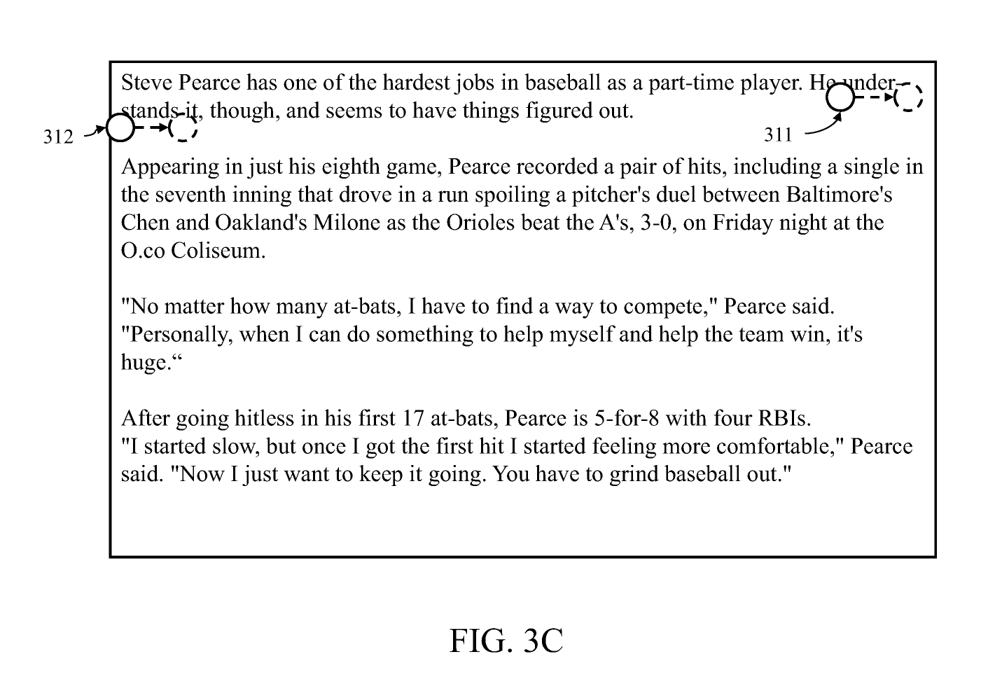

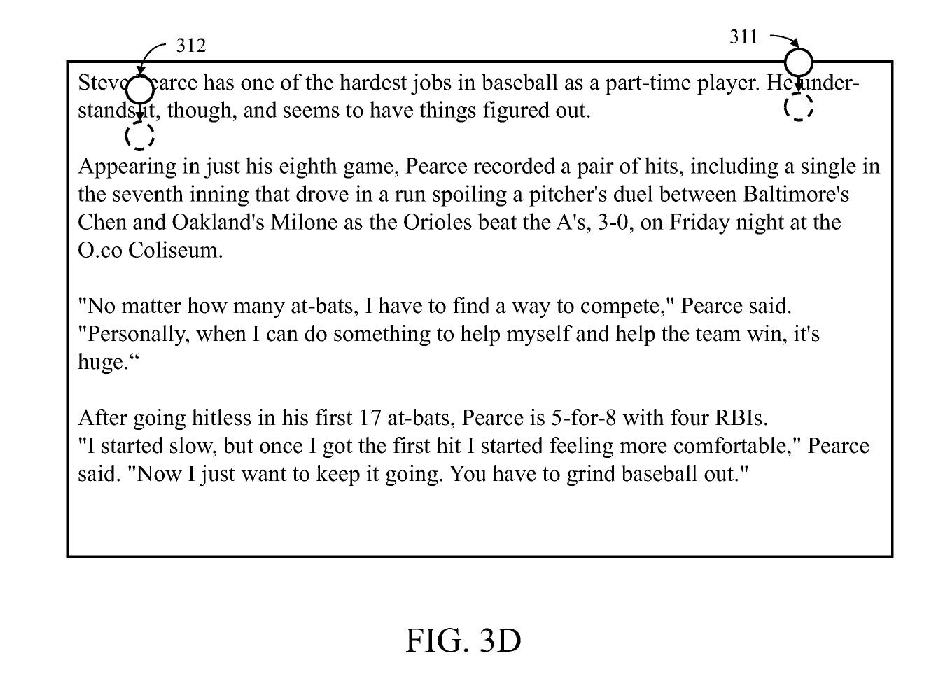

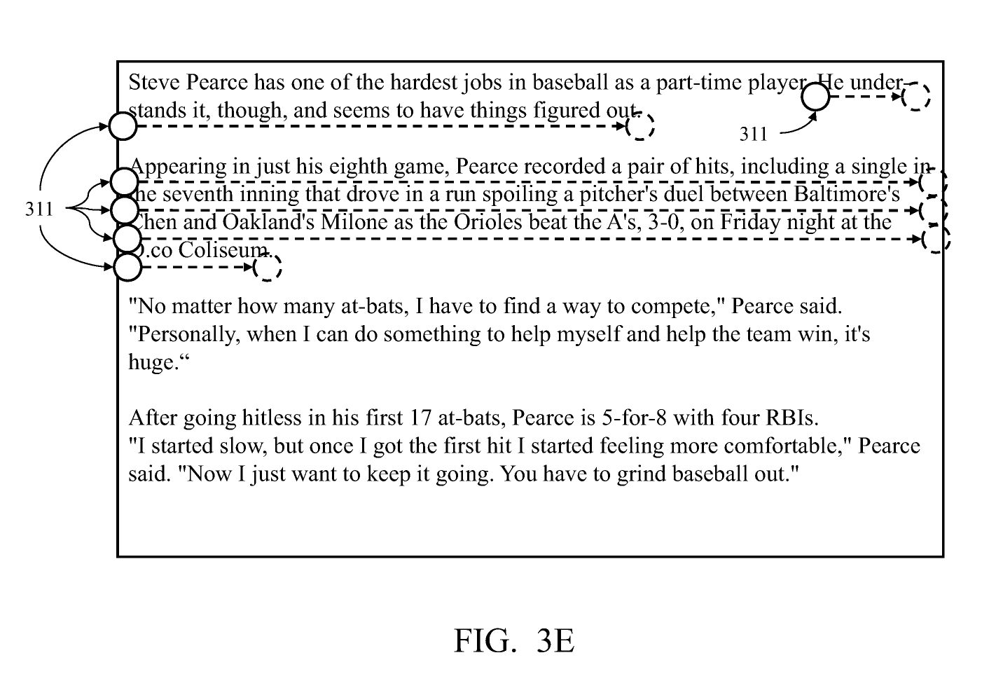

In browsing an article on the touch device by a user, if the user expect to translate the target word in the article, i.e. the text in the specification, displayed on the touch device, the inputting module 110 provide a inputting a gesture on the article content, i.e. the text herein (Step 210). In this embodiment, as shown in FIG. 3A, a user slides his fingers from left to right over top and below of the target word “when I can do something to help myself and help the team win, its huge” to be translated, in an attempt to input the gesture through the inputting module 110.

After inputting the gesture (S210), the selection module 120 selects the target word based on the gesture on the text (S220). In this embodiment, the selection module 120 select the target word according a shorter distance that two fingers 311 and 312 sliding.

In fact, as shown in FIG. 3B, to slide from top to bottom at both left and right sides of the target word “personally” to be translated. Also, as shown in FIG. 3C, slide from left to right along a first part “under” of a target word “understands”, and then slide from left to right along a second part “stands” of the same target word. Or, as shown in FIG. 3D, the user may slide the two fingers from top to bottom over the left side “under” (the first portion) and a right side “stands” (the second portion) of the target word, respectively.

Use a finger 311 to slide from left to right along the first word “He” of the target word “He understands it, at the “O.co Coliseum.” to be translated, and keep sliding from left to right along a next row of the target word until the last word “Coliseum” of the target word. This gesture may select the target word.

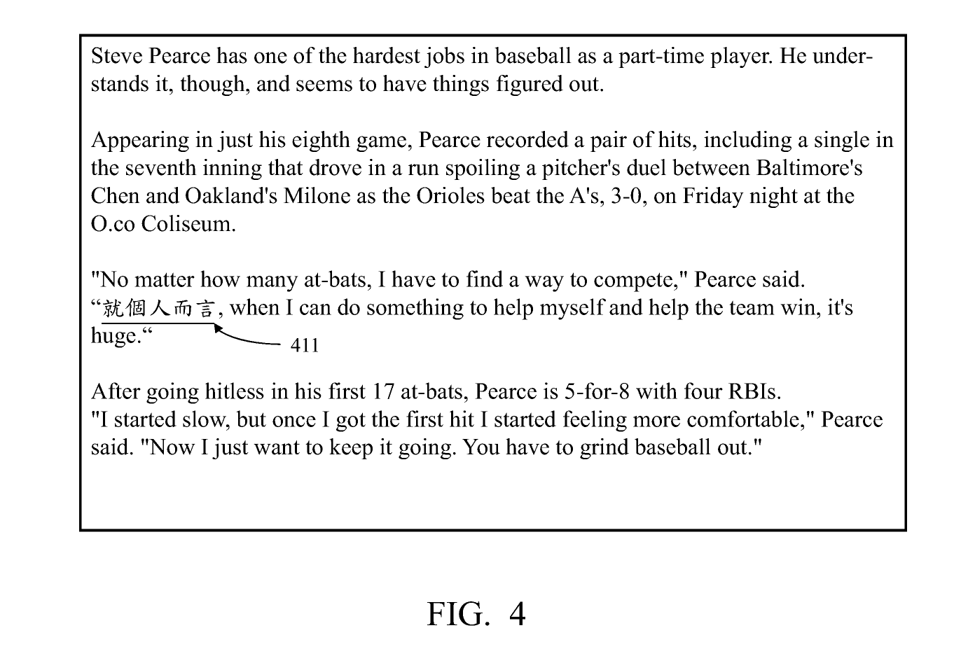

After the selection module 120 selects the target word according to the gesture (S220), the translation module 130 translates the target word into a translation (S230). Thereafter, the displaying module 140 displays the translation generated by the translation module 130 (S240). In this embodiment, the displaying module 140 display the translation 411 on position where the target word “personally” was, as shown in FIG. 4.

As such, a user may utilize the technique of the present invention where a translation of a target word by a gesture on a touch device, without switch to translated software for the target word, improving translation convenience.

In view of the above, the present invention has its feature, compared with the prior art, where inputting gesture on the text, a target word selected according to the gesture is translated into a translation and displayed. In such way, it's convenience for translation on a touch device. It may rapidly get a translation of a target word.

In the above embodiment, the input module 110 may provide to input a withdraw gesture which is opposite direction to the gesture (S250). The display module 140 displays again the target word corresponding to the gesture at the initial position (S260), to restore the display of the translation to the target word.

Furthermore, the method of translating a target word by a gesture may be implemented in hardware, software or a combination of hardware and software, or in some discrete computer systems connected with one another in a discrete manner.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of translating a target word by gesturing, comprising steps of:
inputting a gesture on the text;
selecting a target word by the gesture, the target word belonging the text;
translating the target word into a second language as a translation; and
displaying the translation.

2. The method as claimed in claim 1, wherein the step of inputting the gesture on the text, comprises a step of sliding over top and below of the target word.

3. The method as claimed in claim 1, wherein the step of inputting the gesture on the text comprises a step of sliding over right and left of the target word.

4. The method as claimed in claim 1, wherein the step of inputting the gesture on the text comprises a step of selecting the range of the target word including a part of the target word slid over top or below and the other part of the target word slid after sliding over top or below the part, wherein the other part of the target word is on the next row of the part of the target word.

5. The method as claimed in claim 1, wherein the step of inputting the gesture on the text comprises a step of selecting the range of the target word including a part of the target word slid over top or below and the other part of the target word slid within a set time after slid over top or below the part, wherein the other part includes at least one row of the target word following the part.

6. The method as claimed in claim 1, wherein the step of selecting the target word on the gesture, comprises a step of selecting the range of the target word according to a shorter sliding distance over top and below of the target word.

7. The method as claimed in claim 1, wherein the step of selecting the target word on the gesture comprises a step of selecting the range of the target word from the text according to an overlapping percent that the gesture on each row of the text.

8. The method as claimed in claim 1, wherein the step of selecting the target word on the gesture comprises a step of selecting the range of the target word from the text according to the beginning of a first sliding gesture and the end of a second sliding gesture on the text.

9. The method as claimed in claim 7, wherein the step of displaying the translation comprises a step of displaying the translation on position that in instead of the target word where the target word was.

10. The method as claimed in claim 9, further comprising steps of:
inputting a withdraw gesture which is opposite direction of the gesture; and
displaying the target word at an initial position which the target word is.

11. A system of translating a target word by gesturing, comprising:
an inputting module, inputting a gesture on the text;
a selection module, selecting a target word by the gesture, the target word belonging the text;
a translation module, translating the target word into a second language as a translation; and
a displaying module, displaying the translation.

12. The method as claimed in claim 11, wherein the gesture is an action of sliding over top and below of the target word.

13. The method as claimed in claim 11, wherein the gesture is an action of sliding over right and left of the target word.

14. The method as claimed in claim 11, wherein the gesture is an action of selecting a range of the target word including a part of the target word slid over top or below and the other part of the target word slid after sliding over top or below the part, wherein the other part of the target word is following the part of the target word.

15. The method as claimed in claim 11, wherein the gesture is an action of selecting a range of the target word including a part of the target word slid over top or below and the other part of the target word slid within a set time after slid over top or below the part, wherein the other part of the target word includes at least one row of the target word following the part.

16. The method as claimed in claim 1, wherein the selection module selects a range of the target word according to a shorter sliding distance over top and below of the target word.

17. The method as claimed in claim 11, wherein the selection module selects a range of the target word from the text according to an overlapping percent that the gesture on each row of the text.

18. The method as claimed in claim 11, wherein the selection module selects a range of the target word from the text according to the beginning of a first sliding gesture and the end of a second sliding gesture on the text.

19. The method as claimed in claim 1, wherein the displaying module displays the translation on position that in instead of the target word where the target word was.

20. The method as claimed in claim 19, wherein:
the inputting module further inputs a withdraw gesture which is opposite direction of the gesture; and
the displaying module further displays the target word again at an initial position which the target word is.
